(19) United States
(12) Patent Application Publication
(10) Pub. No.: US 2017/0321462 A1
(43) Pub. Date: Nov. 9, 2017

(54) CONCEALED HINGE ASSEMBLY FOR A DOOR

(71) Applicant: David Johannes MAC DONALD, Alberton, Gauteng (ZA)

(72) Inventor: David Johannes MAC DONALD, Alberton, Gauteng (ZA)

(21) Appl. No.: 15/526,504

(22) PCT Filed: Oct. 19, 2015
(86) PCT No.: PCT/IB2015/058020

§ 371 Date: May 12, 2017

(30) Foreign Application Priority Data
Nov. 12, 2014 (ZA) 2014/08268

(51) Int. Cl. E05D 7/081; B65D 90/00

(52) U.S. Cl. CPC E05D 7/081; B65D 90/008; E05Y 2900/132; E05Y 2400/10

(57) ABSTRACT

The invention relates to a concealed pivot hinge assembly [10] suitable for hingedly mounting a door [12] to a frame, particularly, although not exclusively, for connecting doors of storage, shipping and cargo containers, such as those which may be used on ships, rail lines and trucks, to a container in order to protect against theft. The concealed pivot hinge assembly [10] is characterised therein that it comprises a continuous, elongate hinge extending between and pivotably secured at two opposing ends thereof to the frame such that the hinge assembly [10] also constitutes a door post about which the door [12] is swiveled. The hinge assembly [10] comprises an internal axle shaft [18] which is secured at two opposing ends thereof to the frame; and an external load-bearing shaft [20] which extends coaxially with the internal shaft [18] and is pivotally secured at two opposing ends thereof to the frame such that the external shaft [20] is pivotable relative to the internal shaft [18], the arrangement being such that the door [12] is secured to the external shaft [20] so that pivoting of the external shaft [20] swivels the door [12] between a closed and an open position. The invention extends to a door [12] and a container [44] including such a concealed hinge assembly [10]. The invention also includes a remotely operable locking mechanism [56] for use in connection with such doors [12].

The invention relates to a concealed hinge assembly suitable for connecting a door to a frame. Particularly, although not exclusively, the invention relates to a concealed pivot hinge for connecting doors of storage, shipping and cargo containers, such as those which may be used on ships, rail lines and trucks, to a container in order to protect against theft. The invention extends to a door and a container including such a concealed hinge assembly. The invention also includes a remotely operable locking mechanism for use in connection with such doors.

### BACKGROUND TO THE INVENTION

Large cargo or freight containers, such as those that are detachable from and are formed as part of trailers or semitrailers, are the most commonly used means of transporting large volumes of varying cargos from location to location around the world. A primary advantage to their use is that the large cargo containers can store large quantities of goods and can effectively be transported on boats, trains and/or trucks in order to expeditiously arrive at their eventual destination. The dimensions of such containers have been established and controlled by the International Standards Organisation (ISO). The detachability and adaptability of containers is of particular importance because the containers will often change hands from one carrier to the next, such as from a train to a truck, or from a trucking company to a steamship line, during the various legs of a transport route.

Naturally, due to the great volume and often valuable nature of the cargos being transported in such cargo containers, security is an important consideration when dealing with cargo transportation. The two most prevalent security concerns when it comes to cargo transportation is (i) third party hijackers or thieves, who do not generally care if they leave signs of a break-in, and (ii) internal and not obviously detectable theft. For example, it is sometimes an all too common occurrence that during transit, an individual placed in custody of a container, such as a truck driver in charge of transporting the cargo from point to point, is behind a robbery. Such an individual is naturally very familiar with the nature of the cargo on board, and can easily arrange for a safe rendezvous for the removal of all or part of the cargo contained within a large container.

The doors of such containers have always been the most vulnerable area for illegal entry into a cargo space. As is well known, a cargo container usually has two access doors, commonly of steel construction, which are hingedly mounted at one end of the container by means of respective sets of hinges and mounting brackets, which connect one edge of each door to a respective container doorpost. Hinge pivot pins are typically welded in position during construction so as to render them impossible to remove without significant mechanical damage.

Usually, latching elements and locking bars are provided to maintain the doors in a closed position. The locking bar is typically pivotally mounted opposite the door hinges and is positionable between an open or unlocked position, and a closed or locked position. In the locked position, the locking bar is typically held in position by a shackle, a customs seal, a padlock, or the like. However, the hinges to which the locking bar is pivotally mounted may have fasteners, such as screws or bolts, which are readily accessible and/or removable, such that the locking bar may be defeated by removing the hinges rather than tampering with the shackle, seal, or padlock.

Three methods are usually used to steal from cargo containers: (i) breaking the locking bars and forcing the doors, (ii) cutting an opening in the walls of the container, or (iii) removing the pins that hold the door hinges in place and removing the doors. With the availability of high powered battery-operated hacksaws, and sophisticated adhesives commonly known as “liquid metal”, it has become relatively easy to cut through the locking bar which has the customs seal, or to cut through the hinges that connect the doors to the container posts. Upon subsequent closing of the doors, when illegal entry into the container has taken place, a small amount of liquid metal can be applied to the saw cut, and the joint is re-made, leaving the container apparently unaltered, unless a detailed inspection is carried out.

A single-use seal commonly secures a door latch in a door closed position, and yet thieves continue to find ways to unlatch the doors without actually breaking the seal. Specifically, a joint between an actuation handle and the locking bar on most conventional containers generally incorporates a single bolt securing both elements with one another. As a result, a thief can merely cut or drill out and remove that bolt to permit the independent turning of the locking bar while the actuation handle remains in place, thereby opening the container without having to move the actuation handle or break the seal. Once the cargo has been removed and the door is re-closed, a replacement bolt is merely inserted to connect the actuation handle with the locking bar, and can be painted over if necessary to preserve the original appearance. As a result, the identifying seal has never been removed and no evidence of tampering is available as the cargo changes hands from one carrier to another. Accordingly, when the specific carrier involved in the theft arrives at a next leg of the transport, the container looks normal and intact, and the responsibility is passed on to the next transport carrier.

It is an object of the invention to provide a concealed hinge suitable for connecting doors to a cargo container which will overcome, or at least alleviate, the problem of theft from such containers through removal of or tampering with the door hinges.

It is a further object of the present invention to provide a remotely operable locking means for sealing the doors of a cargo container so as to overcome, or at least alleviate, the problem of theft from such containers through unlatching the doors without breaking the customs seal.

### SUMMARY OF THE INVENTION

For purposes of this specification, the term “freight container” is used to denote all types of transport containers, such as storage, shipping and cargo containers.

According to the invention there is provided a concealed pivot hinge assembly suitable for hingedly mounting a door to a frame wherein the frame includes a base and a parallel, vertically spaced lintel, the hinge assembly being characterised therein that it comprises a continuous, elongate hinge extending between and pivotably secured at two opposing ends thereof to the base and lintel respectively such that the hinge assembly also constitutes a door post about which the door is swiveled, the hinge assembly comprising—

an internal axle shaft which is secured at two opposing ends thereof to the base and lintel respectively;

an external load-bearing shaft which extends coaxially with the internal shaft and is pivotally secured at two opposing ends thereof to the base and lintel such that the external shaft is pivotable relative to the internal shaft,

the arrangement being such that the door is secured to the external shaft so that pivoting of the external shaft swivels the door between a closed and an open position.

Both the internal and external shafts may be secured at opposing ends thereof within the base and lintel respectively of the frame. In one embodiment of the invention, the internal shaft may also pivotally be secured within the base and lintel such that both the internal and external shafts are pivotable, with the external shaft also being pivotable relative to the internal shaft.

The hinge assembly may include at least one pivot assembly for pivoting the hinge so as to swivel the door between the closed and open positions. In particular, the hinge assembly may include a bottom pivot assembly which is arranged approximate a bottom end of the hinge, the bottom pivot assembly being characterised therein that it is encased within the base and inaccessible from outside of the frame; and a top pivot assembly which is arranged approximate a top end of the hinge, the top pivot assembly being characterised therein that it is encased within the lintel and inaccessible from outside of the frame.

The bottom pivot assembly secures the internal and external shafts of the hinge within the base of the frame such that the external shaft is rotatable relative to the internal shaft, the bottom pivot assembly including at least one load-bearing thrust bearing concentrically positioned with the internal shaft and mounted beneath the bottom end of the external shaft such that the thrust bearing carries the axle load of the external shaft.

The bottom pivot assembly further may include at least one load-bearing pin engaging the bottom end of the internal shaft for anchoring the internal shaft within the base, the arrangement being such that the thrust bearing is mounted circumferentially about the load-bearing pin. In one embodiment of the invention, the internal shaft may rotatably be secured within the base and lentil of the frame, with the load-bearing pin being a pivot pin for pivotally anchoring the internal shaft within the base. In this embodiment of the invention the bottom pivot assembly also may include a pivot bearing in which the load-bearing pivot pin is mounted for pivoting the pivot pin and internal shaft within the base.

The bottom pivot assembly further may include at least one washer mounted intermediate the bottom end of the external shaft and the thrust bearing and peripherally engaging the pivot pin such that the external shaft rests upon the washer and the thrust bearing and mechanically cooperates with the internal shaft through the washer. In this embodiment of the invention, where the internal shaft is also pivotable about the load-bearing pivot pin, swiveling of the door between a closed and an open position is achieved through pivoting of the external shaft by means of the washer and thrust bearing, while at the same time the load-bearing pivot pin pivots the internal shaft by means of the pivot bearing and the washer.

The bottom pivot assembly may be characterised therein that the thrust bearing and the pivot bearing have different inner and outer diameters. In particular, the thrust bearing may have a larger inner and outer diameter than the pivot bearing.

The bottom pivot assembly may be housed within a bottom pivot housing which is complimentarily dimensioned to receive at least the load-bearing pivot pin, pivot bearing and thrust bearing.

The top pivot assembly secures the internal and external shafts within the lintel of the frame such that the external shaft is rotatable relative to the internal shaft. The top pivot assembly includes at least one anchoring pin engaging the top end of the internal shaft for securing the internal shaft within the lintel. In the embodiment of the invention wherein the internal shaft is rotatably secured within the frame, the anchoring pin is a pivot pin for rotatably securing the internal shaft within the lintel. In this embodiment of the invention the top pivot assembly also may include a pivot bearing within which the anchoring pivot pin is mounted for pivoting the pivot pin and internal shaft within the lintel.

The top pivot assembly further may include at least one washer mounted intermediate the top end of the external shaft and the pivot bearing and peripherally engaging the anchoring pivot pin such that the external shaft engages the washer and mechanically cooperates with the internal shaft through the washer, the arrangement being such that when the door is swiveled between a closed and an open position, the external shaft is pivoted by means of the washer, while at the same time the anchoring pivot pin pivots the internal shaft by means of the pivot bearing and the washer.

The top pivot assembly may be housed within a top pivot housing which is complimentarily dimensioned to receive at least the anchoring pivot pin and pivot bearing.

The hinge assembly is characterised therein that it enables the door to open more than ninety degrees. Particularly, the door is capable of opening more than hundred-and-eighty degrees, and more particularly up to two hundred and seventy degrees.

The hinge assembly may be suitable for, although not limited to, connecting doors to one end of a freight container. In this application, the hinge assembly further may include a concealed locking rebate dimensioned for sealing a narrow elongate gap between the pivoting external shaft of the hinge assembly and a wall of the container. The locking rebate may comprise an L-shaped hinge plate which is secured to and extends radially outwardly from the external shaft of the hinge assembly; and a complimentarily dimensioned L-shaped locking plate which is secured to and extends from an interior surface of a wall of the container such that when the door is in the closed position, the L-shaped hinge plate engages and cooperates with the complimentarily dimensioned L-shaped locking plate to seal the elongate gap between the hinge assembly and container wall.

The L-shaped hinge plate may be connected to and extend substantially the length of the external shaft between the base and the lintel.

According to a further aspect of the invention there is provided a door which is hingedly mounted to a frame by means of the concealed pivot hinge assembly as set out herein. More particularly, the invention provides a door for a freight container wherein the door is pivotably secured at one edge thereof to an open end of the freight container by means of the hinge assembly as set out herein.

According to a further aspect of the invention there is provided a freight container which is fitted with one or more doors which are mounted by means of the concealed hinge assembly as set out herein. More particularly, there is provided a freight container having two access doors which are hingedly mounted at one end of the container by means of respective sets of hinge assemblies according to the invention which connect one edge of each door to the container.

According to a further aspect of the invention there is provided a door which is hingedly mounted to a frame by means of the concealed pivot hinge assembly as set out herein, and which further includes a remotely operable security locking mechanism for locking the door to the frame, the locking mechanism comprising—

deadbolt means having a locked position and an unlocked position, the deadbolt means including at least one deadbolt plunger, and a crank arm coupled to the plunger for sliding the plunger between the locked and unlocked positions of the deadbolt means,

an actuator operably connected to the deadbolt means;

a receiver capable of receiving a selected electrical or electronic signal and coupled to the actuator to cause the actuator to be energized upon receiving the selected electrical or electronic signal to move the deadbolt means between the locked and the unlocked positions; and

a transmitter remote from the receiver and capable of transmitting the selected electrical or electronic signal to said receiver.

The frame may include receiving means for receiving a portion of the deadbolt means and securing the deadbolt means when in the locked position, thus securing the door to the frame. In particular, the frame may include receiving means within both the base and lintel which are complimentarily dimensioned for receiving a portion of the deadbolt means therein.

In the illustrated embodiment of the invention the deadbolt means includes two co-axial deadbolt plungers which are vertically displaceable in opposite directions between the locked and unlocked position such that one plunger is secured in the lintel receiving means and the other plunger is secured in the base receiving means when the deadbolt means is in the locked position.

The deadbolt plungers may hingedly be coupled to two crank arms, which are in turn hingedly coupled to the actuator for vertical displacement of the deadbolt means.

The security locking mechanism may be locked and unlocked by means of a remotely activated cell phone signal.

The door may be configured to seal one end of a freight container.

According to a further aspect of the invention there is provided a freight container which is fitted with one or more doors which includes the concealed pivot assembly and the remotely operable security locking mechanism as set out herein.

The freight container further may include tracking means, such as GPS tracking, to track the container position in real time anywhere in the world.

### SPECIFIC EMBODIMENT OF THE INVENTION

Without limiting the scope thereof, the invention will now further be described by way of example only and with reference to the accompanying drawings in which—

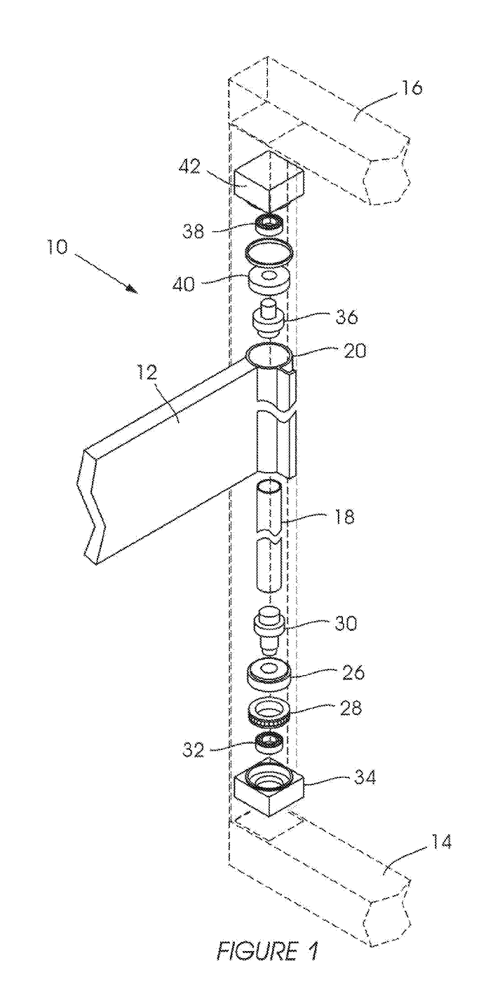

FIG. 1 is an exploded perspective view of a hinge assembly according to the invention;

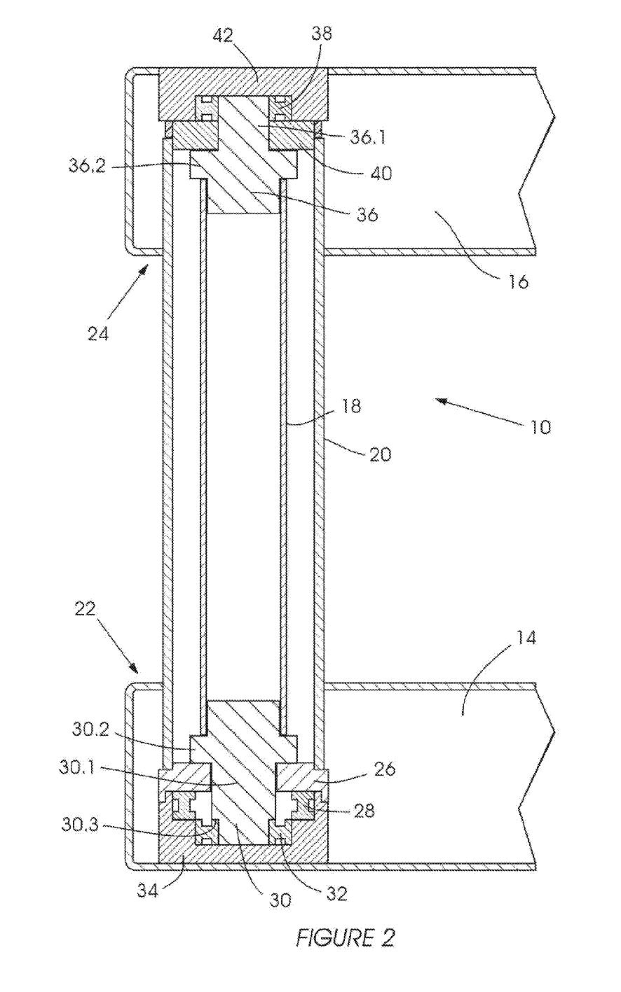

FIG. 2 is an assembled, cross-sectional plan view on the elongate axis of the hinge assembly of FIG. 1;

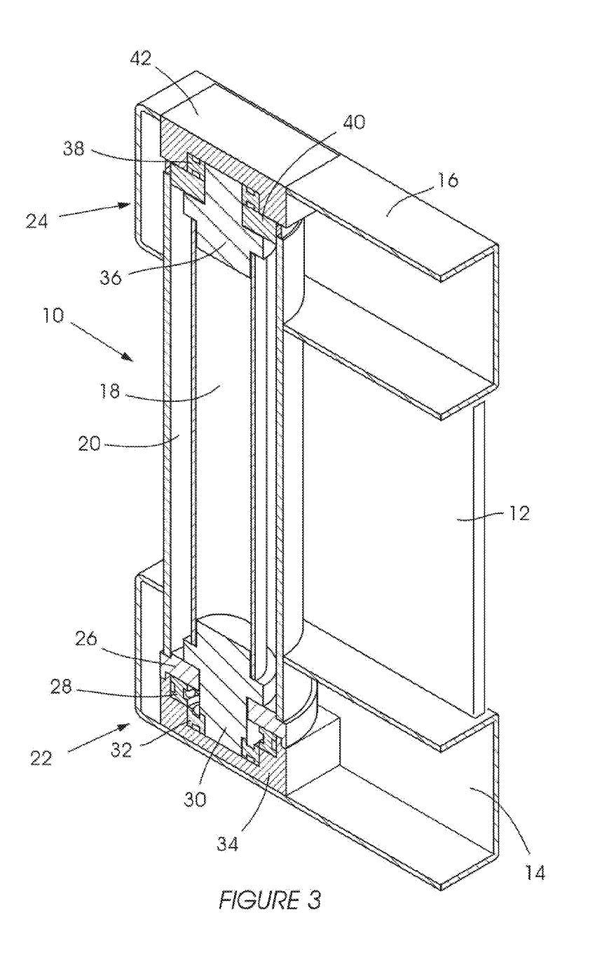

FIG. 3 is an assembled, cross-sectional perspective view of the hinge assembly of FIG. 2;

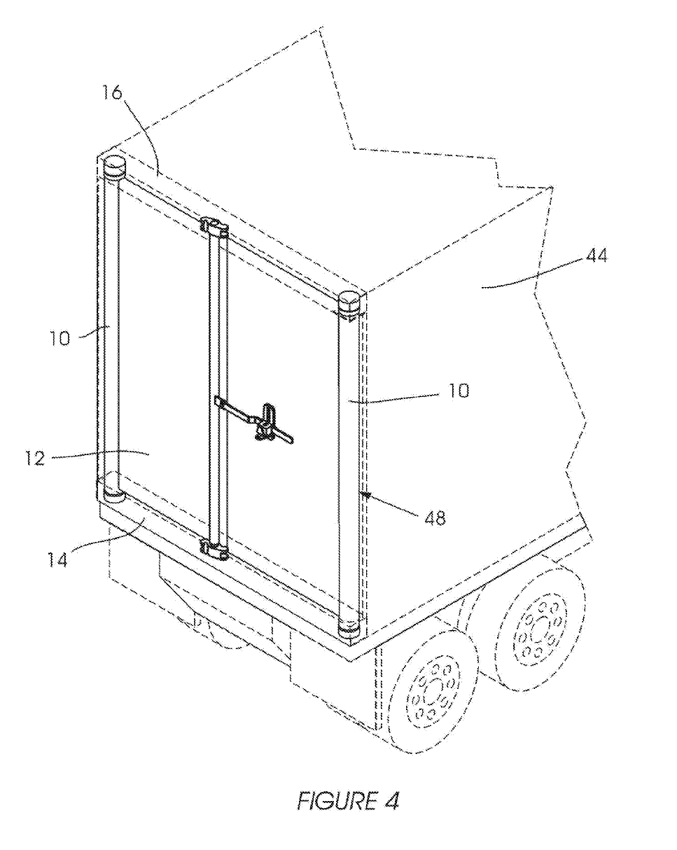

FIG. 4 is a diagrammatical illustration of the use of the hinge assembly of the invention to secure doors to a freight container;

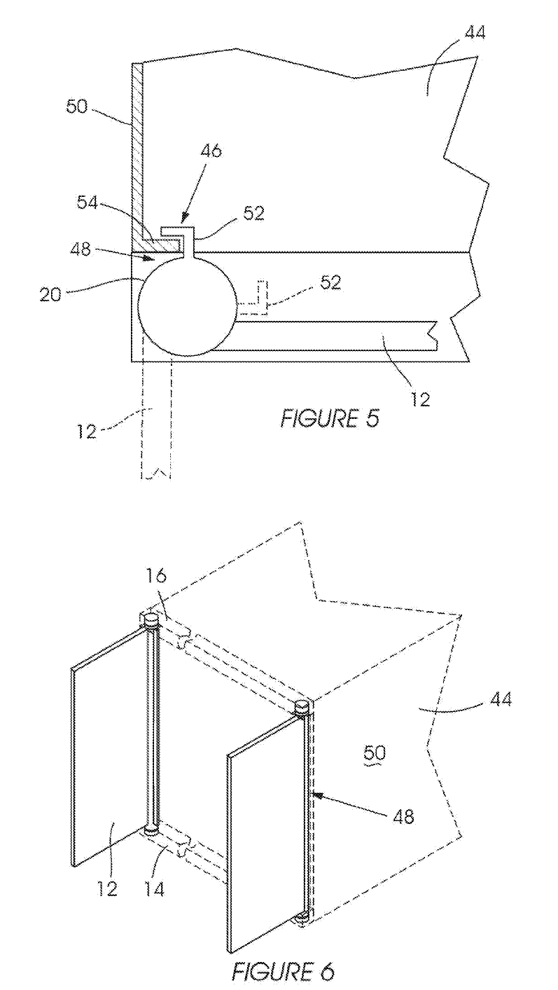

FIG. 5 is a cross-sectional plan view from above of the hinge-assembly of the invention, mounted to a frame and illustrating the concealed, locking rebate;

FIG. 6 is a diagrammatical illustration of the use of the hinge assembly of FIG. 4, with the doors in a partially open position;

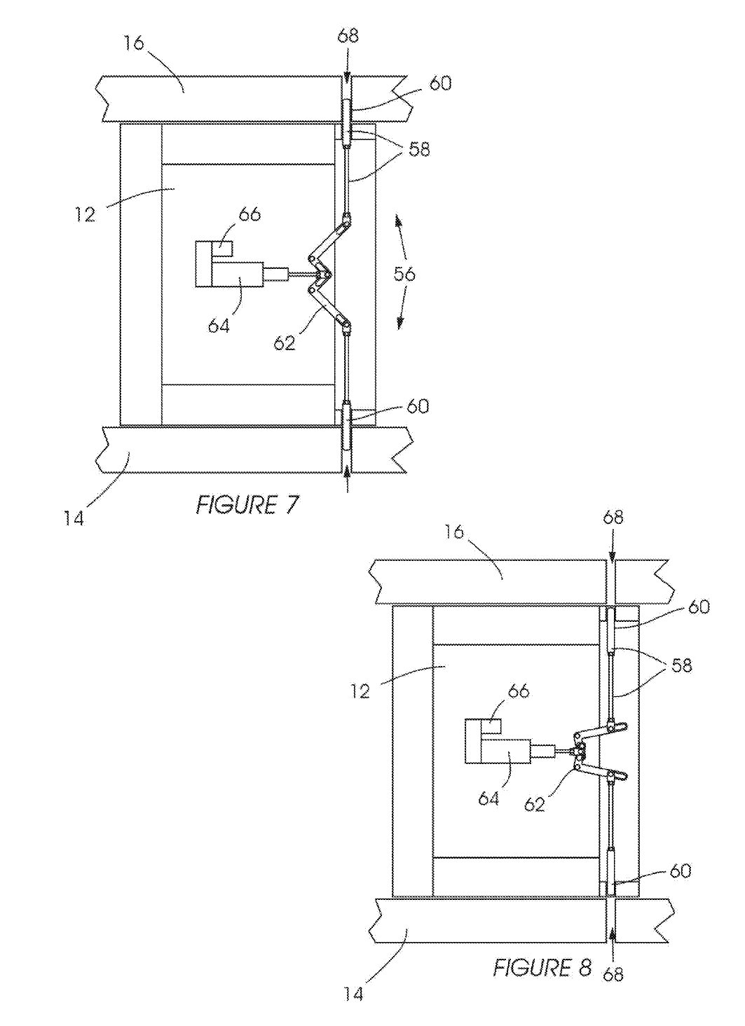

FIG. 7 is a diagrammatical illustration of an internal face of a freight container door incorporating the locking mechanism according to the invention, with the locking mechanism in a locked position;

FIG. 8 is a diagrammatical illustration of the locking mechanism of FIG. 7, with the locking mechanism in an unlocked position;

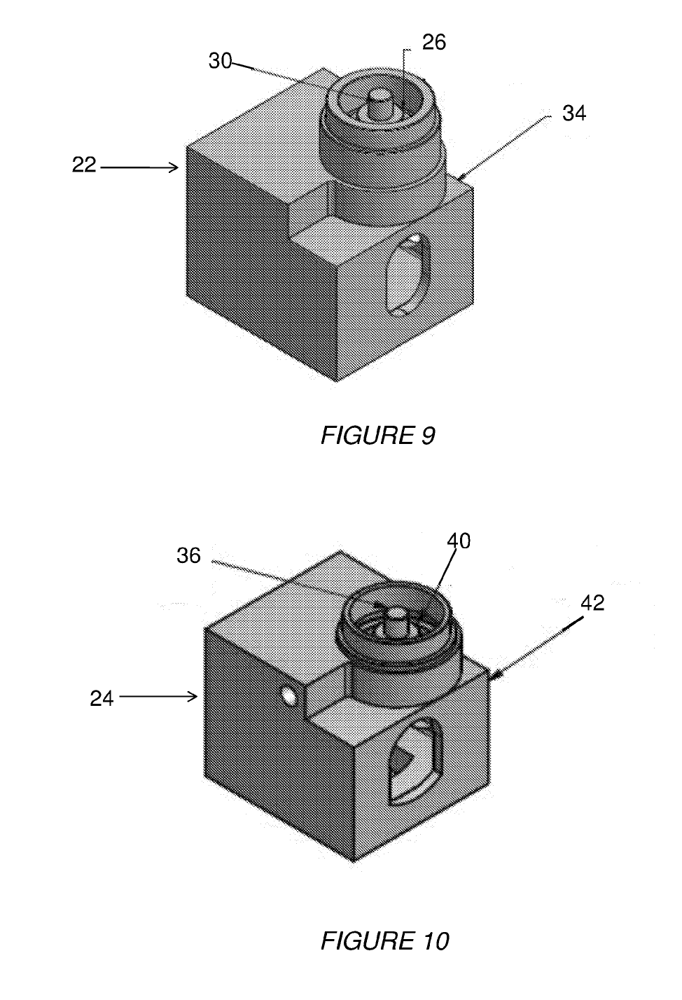

FIG. 9 is an enlarged perspective view of one embodiment of a bottom pivot assembly according to the invention;

FIG. 10 is an enlarged perspective view of one embodiment of a top pivot assembly according to the invention;

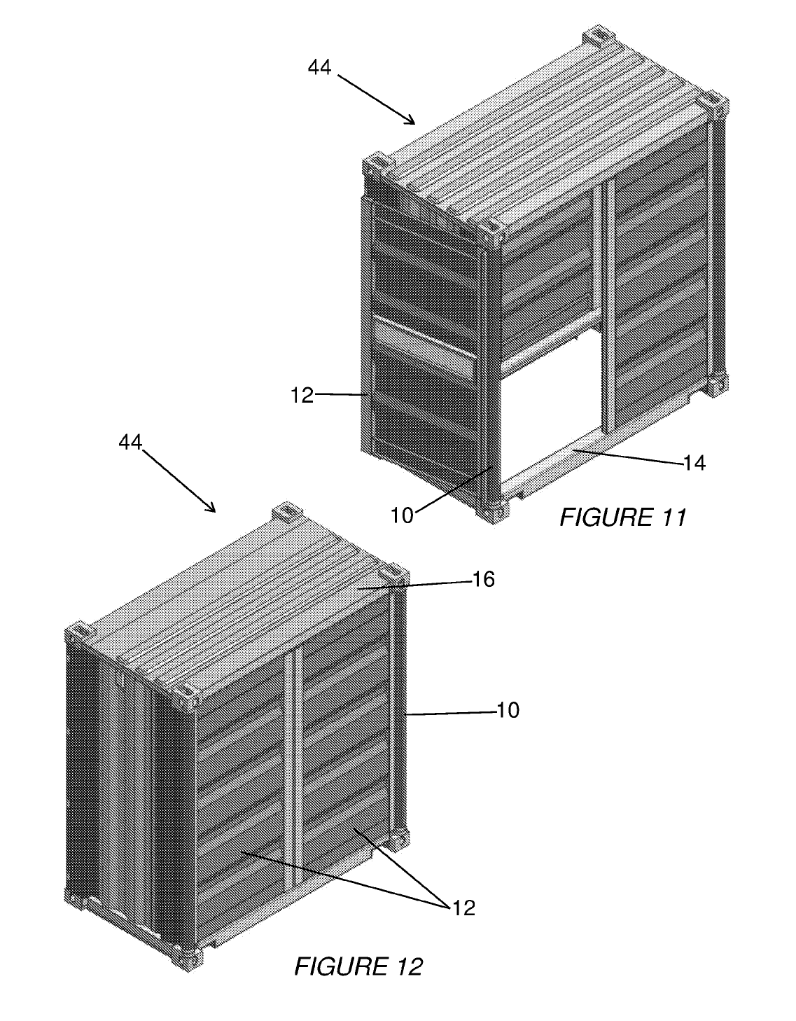

FIG. 11 is a perspective view of an alternative freight container illustrating positioning of the hinge assembly of the invention, with one container door in an open position; and

FIG. 12 is a perspective view of the freight container of FIG. 11 with both container doors in a closed position.

A concealed pivot hinge assembly according to the invention is generally designated by reference numeral [10]. The hinge assembly [10] is suitable for hingedly mounting a door [12] to a frame wherein the frame includes a base [14] and a parallel, vertically spaced lintel [16]. The hinge assembly [10] is characterised therein that it comprises a continuous, elongate hinge extending between and pivotably secured at two opposing ends thereof to the base [14] and lintel [16] respectively such that the hinge assembly [10] also constitutes a door post about which the door [12] is swiveled.

The hinge assembly [10] comprises an internal axle shaft [18] which is secured at two opposing ends thereof to the base [14] and lintel [16] respectively; and an external load-bearing shaft [20] which extends coaxially with the internal shaft [18] and is pivotally secured at two opposing ends thereof to the base [14] and lintel [16] such that the external shaft [20] is pivotable relative to the internal shaft [18]. The door [12] is secured to the external shaft [20] so that pivoting of the external shaft [20] swivels the door [12] between a closed position (see FIGS. 4 and 11) and an open position (see FIGS. 6 and 12).

Both the internal and external shafts [18; 20] protrude into and are secured at opposing ends thereof within the base [14] and lintel [16] respectively of the frame. In the illustrated embodiment of the invention, the internal shaft [18] is also pivotally secured within the base [14] and lintel [16] such that both the internal and external shafts [18; 20] are pivotable, with the external shaft [20] also being pivotable relative to the internal shaft [18].

The illustrated hinge assembly [10] includes two pivot assemblies [22; 24] for pivoting the hinge so as to swivel the door [12] between the closed and open positions. In particular, the hinge assembly [10] includes a bottom pivot assembly [22] which is arranged approximate a bottom end of the hinge and which is characterised therein that it is encased within the base [14] and inaccessible from outside of the frame. The hinge assembly [10] also includes a top pivot assembly [24] which is arranged approximate a top end of the hinge and which is characterised therein that it is encased within the lintel [16] and inaccessible from outside of the frame.

The bottom pivot assembly [22] secures the internal and external shafts [18; 20] of the hinge assembly [10] within the base [14] of the frame such that the external shaft [20] is rotatable relative to the internal shaft [18]. The bottom pivot assembly [22] includes at least one load-bearing thrust bearing [28] which is concentrically positioned with the internal shaft [18] and mounted beneath the bottom end of the external shaft [20] such that the thrust bearing [28] carries the axle load of the external shaft [20].

The bottom pivot assembly [22] further includes at least one load-bearing pin [30] engaging the bottom end of the internal shaft [18] for anchoring the internal shaft [18] within the base [14], the arrangement being such that the thrust bearing [28] is mounted circumferentially about the load-bearing pin [30]. In this embodiment of the invention, the internal shaft [18] is rotatably secured within the base [14] and lentil [16] of the frame, with the load-bearing pin [30] being a pivot pin for rotatably anchoring the internal shaft [18] within the base [14]. In this embodiment of the invention the bottom pivot assembly [22] also includes a pivot bearing [32] in which the load-bearing pivot pin [30] is mounted for pivoting the pivot pin [30] and internal shaft [18] within the base [14].

The load-bearing pivot pin [30] includes a cylinder [30.1] and a peripheral flange [30.2] extending radially outwardly from the cylinder [30.1], the arrangement being such that an upper end of the cylinder is partially forced and snugly fitted into the internal shaft [18] so that the bottom end of the internal shaft [18] rests upon the peripheral flange [30.2] of the load-bearing pivot pin [30]. The opposite lower end of the pivot pin cylinder [30.1] includes a radially tapered step [30.3] for peripherally accommodating the pivot bearing [32] and thrust bearing [28] respectively in vertically spaced coaxial alignment.

The bottom pivot assembly [22] further includes a washer [26] mounted intermediate the bottom end of the external shaft [20] and the thrust bearing [28] and peripherally engaging the load-bearing pivot pin [30] such that the external shaft [20] rests upon the washer [26] and the thrust bearing [28] and mechanically cooperates with the internal shaft [18] through the washer [26]. In this embodiment of the invention, where the internal shaft [18] is also pivotable about the load-bearing pivot pin [30], swiveling of the door [12] between a closed and an open position is achieved through pivoting of the external shaft [20] by means of the washer [26] and thrust bearing [28], while at the same time the load-bearing pivot pin [30] pivots the internal shaft [18] by means of the pivot bearing [32] and the washer [26].

The bottom pivot assembly [22] is characterised therein that the thrust bearing [28] and the pivot bearing [32] have different inner and outer diameters, particularly with the thrust bearing [28] having a larger inner and outer diameter than the pivot bearing [32].

The bottom pivot assembly [22] is housed within a bottom pivot housing [34] which is complimentarily dimensioned to receive at least the load-bearing pivot pin [30], pivot bearing [32] and thrust bearing [28].

The top pivot assembly [24] secures the internal and external shafts [18; 20] within the lintel [16] of the frame such that the external shaft [20] is rotatable relative to the internal shaft [18]. The top pivot assembly [24] includes at least one anchoring pin [36] engaging the top end of the internal shaft [18] for securing the internal shaft [18] within the lintel [16]. In this embodiment of the invention, in which the internal shaft [18] is rotatably secured within the frame, the anchoring pin [36] is a pivot pin for rotatably securing the internal shaft [18] within the lintel [16]. The top pivot assembly [24] also includes a pivot bearing [38] within which the anchoring pivot pin [36] is mounted for pivoting the pivot pin [36] and internal shaft [18] within the lintel [16].

The anchoring pivot pin [36] includes a cylinder [36.1] and a peripheral flange [36.2] extending radially outwardly from the cylinder [36.1], the arrangement being such that a bottom end of the cylinder [36.1] is partially forced and snugly fitted into the internal shaft [18] so that the top end of the internal shaft [18] engages the peripheral flange [36.2] of the anchoring pivot pin [36]. The opposite upper end of the pivot pin cylinder [36.1] is mounted within the pivot bearing [38].

The top pivot assembly [24] further includes at least one washer [40] mounted intermediate the top end of the external shaft [20] and the pivot bearing [38] and peripherally engaging the anchoring pivot pin [36] such that the external shaft [20] engages the washer [40] and mechanically cooperates with the internal shaft [18] through the washer [40], the arrangement being such that when the door [12] is swiveled between a closed and an open position, the external shaft [20] is pivoted by means of the washer [40], while at the same time the anchoring pivot pin [36] pivots the internal shaft [18] by means of the pivot bearing [38] and the washer [40].

The top pivot assembly [24] is housed within a top pivot housing [42] which is complimentarily dimensioned to receive at least the anchoring pivot pin [36] and the pivot bearing [38].

The hinge assembly [10] is characterised therein that it enables the door [12] to open more than ninety degrees, specifically more than hundred-and-eighty degrees, and more specifically up to two hundred and seventy degrees.

The hinge assembly [10] is particularly suitable for, although not limited to, connecting doors to one end of freight containers [44]. In this application, the hinge assembly [10] further includes a concealed locking rebate [46] dimensioned for sealing a narrow elongate gap [48] between the pivoting external shaft [20] of the hinge assembly [10] and a wall [50] of the container [44]. The locking rebate [46] comprises an L-shaped hinge plate [52] which is secured to and extends radially outwardly from the external shaft [20] of the hinge assembly [10]; and a complimentarily dimensioned L-shaped locking plate [54] which is secured to and extends from an interior surface of a wall [50] of the container [44] such that when the door [12] is in the closed position, the L-shaped hinge plate [52] engages and cooperates with the complimentarily dimensioned L-shaped locking plate [54] to seal the elongate gap [48] between the hinge assembly [10] and container wall [50]. The L-shaped hinge plate [52] is connected to and extends substantially the length of the external shaft [20] between the base [14] and the lintel [16].

The concealed locking rebate [46] aims not only to seal the elongate gap [48] between the hinge assembly [10] and the container [44] against environmental factors, but also further to secure the door [12] to the container [44] in the event of theft. Should thieves cut through the concealed hinge assembly [10] approximate the base [14] and the lintel [16] in an attempt to remove the entire hinge assembly [10] and door [12], the concealed locking rebate [46] serves to retain the door [12] against the container [44], thus further complicating removal of the door [12].

The invention finds particular, although not exclusive, application for hingedly mounting a door [12] to a freight container [44] wherein the door [12] is pivotably secured at one edge thereof to an open end of the freight container [44] by means of the hinge assembly [10] as set out herein. It will, however, be appreciated that the hinge assembly [10] can equally well be used to secure doors in other applications, such as pivotally securing safe doors to a safe housing.

The invention also provides for locking the door [12], comprising the concealed pivot hinge assembly [10], by means of a remotely operable security locking mechanism [56] adapted for locking the door [12] to the frame. With reference to FIGS. 7 and 8, the locking mechanism [56] comprises deadbolt means [58] having a locked position (refer FIG. 7) and an unlocked position (refer FIG. 8). The deadbolt means [58] includes two co-axial deadbolt plungers [60], and a crank arm [62] coupled to each plunger [60] for sliding the plungers [60] between the locked and unlocked positions of the deadbolt means. The locking mechanism [56] further includes an actuator [64] which is operably connected to the deadbolt means [58]; a receiver [66] capable of receiving a selected electrical or electronic signal and coupled to the actuator [64] to cause the actuator [64] to be energized upon receiving the selected electrical or electronic signal to move the deadbolt means [58] between the locked and the unlocked positions; and a transmitter (not shown) remote from the receiver [66] and capable of transmitting the selected electrical or electronic signal to the receiver [66].

The frame may include receiving means [68] for receiving at least a portion of the deadbolt means [58] and securing the deadbolt means [58] when in the locked position. In particular, the frame may include receiving means [68] within both the base [14] and lintel [16] which are complimentarily dimensioned for receiving at least a portion of the deadbolt means [58], and particularly the deadbolt plungers [60] therein.

In the illustrated embodiment of the invention the deadbolt means [58] includes two co-axial deadbolt plungers [60] which are vertically displaceable in opposite directions between the locked and unlocked position such that one plunger [60] is secured in the receiving means [68] of the lintel [16], while the other plunger [60] is secured in the receiving means [68] of the base [14] when the deadbolt means [58] is in the locked position.

The deadbolt plungers [60] are hingedly coupled to two crank arms [62], which are in turn hingedly coupled to the actuator [64] for vertical displacement of the deadbolt plungers [60].

It will be appreciated that other embodiments of the invention are possible without departing from the spirit or scope of the invention as set out in the consistory clauses. So, for example, the internal shaft [18] may be a rigid, immovable shaft which is anchored at two opposing ends thereof within the base [14] and lintel [16] respectively, with the external shaft [20] being pivotable about the internal shaft [18] via a bearing arrangement intermediate the internal and external shafts [18; 20].

1. A concealed pivot hinge assembly suitable for hingedly mounting a door to a frame wherein the frame includes a base and a parallel, vertically spaced lintel, the hinge assembly wherein it comprises a continuous, elongate hinge extending between and pivotably secured at two opposing ends thereof to the base and lintel respectively such that the hinge assembly also constitutes a door post about which the door is swiveled, the hinge assembly comprising—
an internal axle shaft which is secured at two opposing ends thereof to the base and lintel respectively;
an external load-bearing shaft which extends coaxially with the internal shaft and is pivotally secured at two opposing ends thereof to the base and lintel such that the external shaft is pivotable relative to the internal shaft,
the arrangement being such that the door is secured to the external shaft so that pivoting of the external shaft swivels the door between a closed and an open position.

2. The concealed pivot hinge assembly according to claim 1 wherein the internal shaft is also pivotally secured within the base and lintel such that both the internal and external shafts are pivotable, with the external shaft also being pivotable relative to the internal shaft.

3. The concealed pivot hinge assembly according to claim 1 wherein the hinge assembly includes at least one pivot assembly for pivoting the hinge so as to swivel the door between the closed and open positions.

4. The concealed pivot hinge assembly according to claim 3 wherein the hinge assembly includes a bottom pivot assembly which is arranged approximate a bottom end of the hinge, the bottom pivot assembly wherein it is encased within the base and inaccessible from outside of the frame; and a top pivot assembly which is arranged approximate a top end of the hinge, the top pivot assembly being characterised therein that it is encased within the lintel and inaccessible from outside of the frame.

5. The concealed pivot hinge assembly according to claim 4 wherein the bottom pivot assembly secures the internal and external shafts of the hinge within the base of the frame such that the external shaft is rotatable relative to the internal shaft, the bottom pivot assembly including at least one load-bearing thrust bearing concentrically positioned with the internal shaft and mounted beneath the bottom end of the external shaft such that the thrust bearing carries the axle load of the external shaft.

6. The concealed pivot hinge assembly according to claim 5 wherein the bottom pivot assembly further includes at least one load-bearing pin engaging the bottom end of the internal shaft for anchoring the internal shaft within the base, the arrangement being such that the thrust bearing is mounted circumferentially about the load-bearing pin.

7. The concealed pivot hinge assembly according to claim 6 wherein the internal shaft is rotatably secured within the base and lentil of the frame, with the load-bearing pines being a pivot pin for pivotally anchoring the internal shaft within the base; the bottom pivot assembly also including a pivot bearing in which the load-bearing pivot pin is mounted for pivoting the pivot pin and internal shaft within the base.

8. The concealed pivot hinge assembly according to claim 7 wherein the bottom pivot assembly further includes at least one washer mounted intermediate the bottom end of the external shaft and the thrust bearing and peripherally engaging the pivot pin such that the external shaft rests upon the washer and the thrust bearing and mechanically cooperates with the internal shaft through the washer.

9. The concealed pivot hinge assembly according to claim 8 wherein the internal shaft also pivotable about the load-bearing pivot pin such that swiveling of the door between a closed and an open position is achieved through pivoting of the external shaft by means of the washer and thrust bearing, while at the same time the load-bearing pivot pin pivots the internal shaft by means of the pivot bearing and the washer.

10. The concealed pivot hinge assembly according to claim 9 wherein the thrust bearings and the pivot bearing of the bottom pivot assembly have different inner and outer diameters.

11. The concealed pivot hinge assembly according to claim 10 wherein the thrust bearing has a larger inner and outer diameter than the pivot bearing.

12. The concealed pivot hinge assembly according to claim 4 wherein the bottom pivot assembly is housed within a bottom pivot housing which is complimentarily dimensioned to receive at least the load-bearing pivot pin, pivot bearing and thrust bearing.

13. The concealed pivot hinge assembly according to claim 4 wherein the top pivot assembly secures the internal and external shafts within the lintel of the frame such that the external shaft is rotatable relative to the internal shaft, the top pivot assembly including at least one anchoring pin engaging the top end of the internal shaft for securing the internal shaft within the lintel.

14. The concealed pivot hinge assembly according to claim 13 wherein the anchoring pin is a pivot pin for rotatably securing the internal shaft within the lintel, the top pivot assembly also including a pivot bearing within which the anchoring pivot pin is mounted for pivoting the pivot pin and internal shaft within the lintel.

15. The concealed pivot hinge assembly according to claim 14 wherein the top pivot assembly further includes at least one washer mounted intermediate the top end of the external shaft and the pivot bearing and peripherally engaging the anchoring pivot pin such that the external shafts engages the washer and mechanically cooperates with the internal shaft through the washer, the arrangement being such that when the door is swiveled between a closed and an open position, the external shaft is pivoted by means of the washer, while at the same time the anchoring pivot pin pivots the internal shaft means of the pivot bearing and the washer.

16. The concealed pivot hinge assembly according to claim 13 wherein the top pivot assembly is housed within a top pivot housing which is complimentarily dimensioned to receive at least the anchoring pivot pin and pivot bearing.

17. The concealed pivot hinge assembly according to claim 1 wherein the hinge assembly enables the door to open more than ninety degrees.

18. The concealed pivot hinge assembly according to claim 17 wherein the hinge assembly enables the door to open more than hundred-and-eighty degrees, and specifically up to two hundred and seventy degrees.

19. The concealed pivot hinge assembly according to claim 1 wherein the hinge assembly is adapted for connecting a door to one end of a freight container.

20. The concealed pivot hinge assembly according to claim 1 wherein the hinge assembly includes a concealed locking rebate dimensioned for sealing a narrow elongate gap between the external load-bearing shaft and a wall of a container; the locking rebate comprising an L-shaped hinge plate which is secured to and extends radially outwardly from the external shaft of the hinge assembly; and a complimentarily dimensioned L-shaped locking plate which is secured to and extends from an interior surface of the wall of the container such that when the door is in the closed position, the L-shaped hinge plate engages and cooperates with the complimentarily dimensioned L-shaped locking plate to seal the elongate gap between the hinge assembly and the container wall.

21. The concealed pivot hinge assembly according to claim 20 wherein the L-shaped hinge plate is connected to and extends substantially the length of the external shaft between the base and the lintel.

22. A door which is hingedly mounted to a frame by means of the concealed pivot hinge assembly according to claim 1.

23. The door according to claim 22 wherein the door is a door of a freight container and wherein the door is pivotably secured at one edge thereof to an open end of the freight container by means of the hinge assembly according to claim 1.

24. A freight container which is fitted with one or more doors wherein the doors are mounted to an open end of the freight container by means of the concealed hinge assembly according to claim 1.

25. The door according to claim 22 wherein the door further includes a remotely operable security locking mechanism for locking the door to the frame, the locking mechanism comprising—
deadbolt means having a locked position and an unlocked position, the deadbolt means including at least one deadbolt plunger, and a crank arm coupled to the plunger for sliding the plunger between the locked and unlocked positions of the deadbolt means,
an actuator operably connected to the deadbolt means;
a receiver capable of receiving a selected electrical or electronic signal and coupled to the actuator to cause the actuator to be energized upon receiving the selected electrical or electronic signal to move the deadbolt means between the locked and the unlocked positions; and
a transmitter remote from the receiver and capable of transmitting the selected electrical or electronic signal to said receiver.

26. The door according to claim 25 wherein the frame includes receiving means for receiving at least a portion of the deadbolt means and securing the deadbolt means when in the locked position, thus securing the door to the frame.

27. The door according to claim 26 wherein the frame includes a base and a lintel with base receiving means located within the base and lintel receiving means located in the lintel of the frame, the receiving means being complimentarily dimensioned for each receiving at least a portion of the deadbolt means therein.

28. The door according to claim 27 wherein the deadbolt means includes two co-axial deadbolt plungers which are vertically displaceable in opposite directions between the locked and unlocked position such that one plunger is secured in the lintel receiving means and the other plunger is secured in the base receiving means when the deadbolt means is in the locked position.

29. The door according to claim 28 wherein the deadbolt plungers are hingedly coupled to two crank arms, which are in turn hingedly coupled to the actuator for displacement of the deadbolt means.

30. The door according to claim 25 wherein the security locking mechanism is locked and unlocked by means of a remotely activated cell phone signal.

31. The door according to claim 25 wherein the door is configured to seal one end of a freight container.

32. A freight container which is fitted with one or more doors wherein the doors are mounted to an open end of the freight container by means of the concealed hinge assembly according to claim 1; and wherein at least one of the doors further includes a remotely operable security locking mechanism.

33. The freight container according to claim 32 wherein the freight container further includes tracking means, such as GPS tracking, to track the container position in real time anywhere in the world.

34. The concealed pivot hinge assembly according to claim 1 wherein the internal shaft is immovably secured within the base and lintel, with the external shaft being pivotable relative to the internal shaft.

35. (canceled)
